(19) United States
(12) Patent Application Publication
(10) Pub. No.: US 2022/0302541 A1
(43) Pub. Date: Sep. 22, 2022

(54) Battery-Cell-to-Battery-Pouch Anchoring System

(71) Applicant: Google LLC, Mountain View, CA (US)

(72) Inventor: Steven Vincent James, San Jose, CA (US)

(73) Assignee: Google LLC, Mountain View, CA (US)

(21) Appl. No.: 17/664,506

(22) Filed: May 23, 2022

Related U.S. Application Data
(60) Provisional application No. 63/365,101, filed on May 20, 2022.

(51) Int. Cl. H01M 50/242; H01M 50/211

(52) U.S. Cl. CPC H01M 50/242; H01M 50/211

(57) ABSTRACT

Techniques and apparatuses are described that anchor a battery cell to a flexible battery pouch, both of which are included in a battery pack. In some implementations, based on an external force (e.g., impact force), an internal mass of the battery cell may push through the flexible battery pouch due to a movement of the battery cell relative to the flexible battery pouch. The disclosed techniques and apparatuses are directed to anchoring the battery cell to the battery pouch by including a plurality of anchors in an adhesive layer included in the battery pack. The plurality of anchors is configured to create friction points against movement of the battery cell relative to the flexible pouch.

### RELATED APPLICATION

This application claims priority under 35 U.S.C. § 119(e) to U.S. Provisional Patent Application 63/365,101, filed on May 20, 2022, which is incorporated herein by reference in its entirety.

### SUMMARY

Techniques and apparatuses are described that anchor a battery cell to a flexible battery pouch, both of which are included in a battery pack. In some implementations, based on an external force (e.g., impact force), an internal mass of the battery cell may push through the flexible battery pouch due to a movement of the battery cell relative to the flexible battery pouch. The disclosed techniques and apparatuses are directed to anchoring the battery cell to the battery pouch by including a plurality of anchors in an adhesive layer included in the battery pack. The plurality of anchors is configured to create friction points to reduce movement of the battery cell relative to the flexible pouch.

In aspects, the battery cell consists of a set of layers wound in a jellyroll assembly. The set of layers includes an insulator layer, a cathode layer, an anode layer, and a separator layer disposed between the cathode layer and the anode layer. An anchoring system configured to anchor the battery cell to the flexible pouch includes the adhesive layer. The adhesive layer includes a first surface configured to contact an outer surface of the battery cell and a second surface opposite the first surface. The second surface includes the plurality of anchors configured to create friction points against movement of the jellyroll assembly relative to the flexible pouch.

This Summary is provided to introduce simplified concepts for a battery cell to battery pouch anchoring system, which is further described below in the Detailed Description and is illustrated in the Drawings. This Summary is not intended to identify essential features of the claimed subject matter, nor is it intended for use in determining the scope of the claimed subject matter.

### BRIEF DESCRIPTION OF THE DRAWINGS

The details of one or more aspects of a battery cell to battery pouch anchoring system are described in this document with reference to the following drawings:

FIG. 1 illustrates a set of layers used in a battery cell;

FIG. 2 illustrates the set of layers from FIG. 1 wound in a jellyroll assembly;

FIG. 3 illustrates a top view of a battery pack, wherein the jellyroll assembly from FIG. 2 is enclosed in a flexible pouch and an adhesive layer is disposed between the flexible pouch and the jellyroll assembly;

FIG. 4 illustrates a front view of the battery pack from FIG. 3;

FIG. 5A illustrates a front view of the adhesive layer from FIG. 3 including bumps;

FIG. 5B illustrates a cross-section view of the adhesive layer from FIG. 5A;

FIG. 6A illustrates a front view of the adhesive layer from FIG. 3 including ripples;

FIG. 6B illustrates a cross-section view of the adhesive layer from FIG. 6A;

FIG. 7A illustrates a front view of the adhesive layer from FIG. 3 including indentations;

FIG. 7B illustrates a cross-section view of the adhesive layer from FIG. 7A;

FIG. 8A illustrates a front view of the adhesive layer from FIG. 3 including holes;

and

FIG. 8B illustrates a cross-section view of the adhesive layer from FIG. 8A.

The use of same numbers in different instances may indicate similar features or components.

### DETAILED DESCRIPTION

### Overview

This document describes techniques and apparatuses directed to anchor a battery cell to a flexible battery pouch. In aspects, the battery cell is a set of layers including an insulator layer, a cathode layer, an anode layer, and a separator layer disposed between the cathode layer and the anode layer. The set of layers is wound in a jellyroll assembly and enclosed by a flexible pouch. The jellyroll assembly is adhered to the flexible pouch by an adhesive layer disposed within the flexible pouch between the flexible pouch and the jellyroll assembly. A pair of electrically conductive tabs are physically connected through the flexible pouch to the cathode and anode layers. The flexible pouch is vacuum-sealed and filled with an electrolytic solution. Altogether, the jellyroll assembly, the adhesive layer, the flexible pouch, and the pair of tabs form a battery pack.

As battery pack dimensions increase, and thus the internal jellyroll assembly becomes more massive, it is increasingly challenging for the battery pack to pass reliability drop and tumble tests. The battery pack can fail when the internal jellyroll assembly pushes through the sealed flexible pouch based on an impact force received when the battery pack, or the device in which the battery pack is installed, is dropped onto a surface (e.g., the ground). This failure mechanism is due to a movement of the jellyroll assembly relative to the flexible pouch and, in some cases, is exacerbated at weak points where the electrically conductive tabs exit the flexible pouch. The failure mechanism can result in a loss of the electrolytic solution, rendering the battery pack useless. Additionally, the set of layers in the jellyroll assembly can move relative to each other, potentially resulting in an electrical short between the cathode layer and the anode layer. The electrical short can cause more severe damage to the battery and a device incorporating the battery.

The techniques and apparatuses described herein are directed to anchor the jellyroll assembly to the flexible battery pouch by including an anchoring system configured to anchor the jellyroll assembly to the flexible battery pouch, which includes a plurality of anchors in the adhesive layer. The plurality of anchors is configured to create friction points against movement of the jellyroll assembly relative to the flexible pouch. This document now turns to example implementations of the battery pack having the adhesive layer with the plurality of anchors and the jellyroll assembly.

### Example Implementations

The following discussion describes example implementations, techniques, and apparatuses that may be employed in the example implementations, and various devices in which components of the example implementations can be embodied. In the context of the present disclosure, reference is made to the following by way of example only.

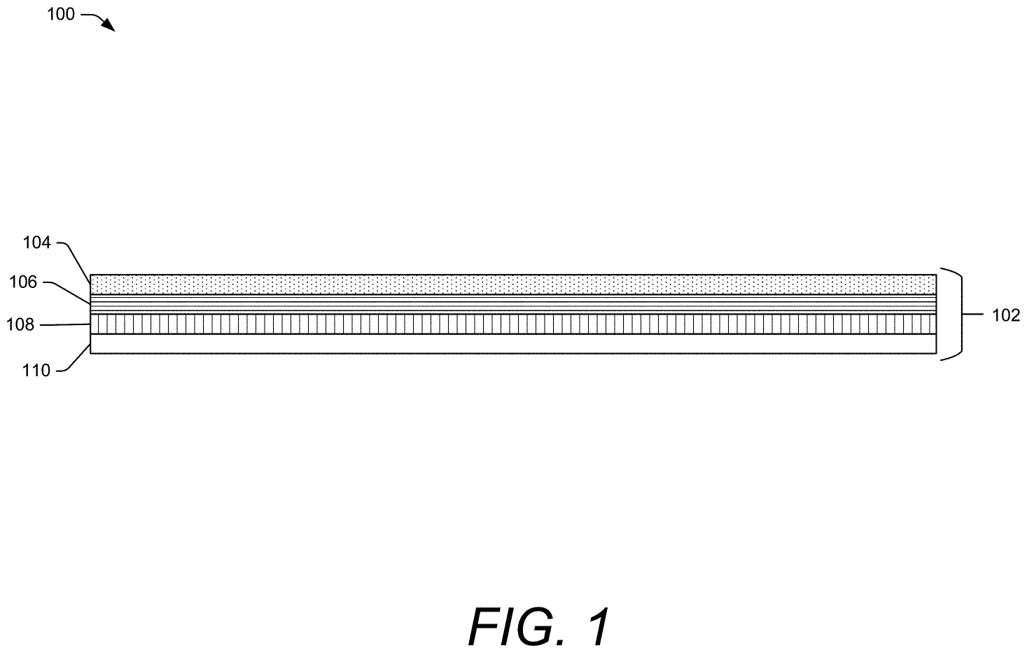

FIG. 1 illustrates an example implementation 100 of a set of layers 102 that may be included in a battery cell. The set of layers 102 includes a cathode layer 104 disposed as a top layer. Disposed beneath the cathode layer 104 is a separator layer 106. Disposed beneath the separator layer 106 is an anode layer 108. Disposed beneath the anode layer 108 is an insulator layer 110. Although a specific ordering of the layers is illustrated in FIG. 1, the specific ordering is an example only. The ordering may be different, so long as the separator layer 106 is disposed between the cathode layer 104 and the anode layer 108, and the insulator layer 110 is disposed adjacent to the cathode layer 104 or the anode layer 108 such that the insulator layer 110 and the separator layer 106 are on opposing sides of the cathode layer 104 or the anode layer 108. In one example, the cathode layer 104 may be between the separator layer 106 and the insulator layer 110. In another example, the anode layer 108 may be between the separator layer 106 and the insulator layer 110.

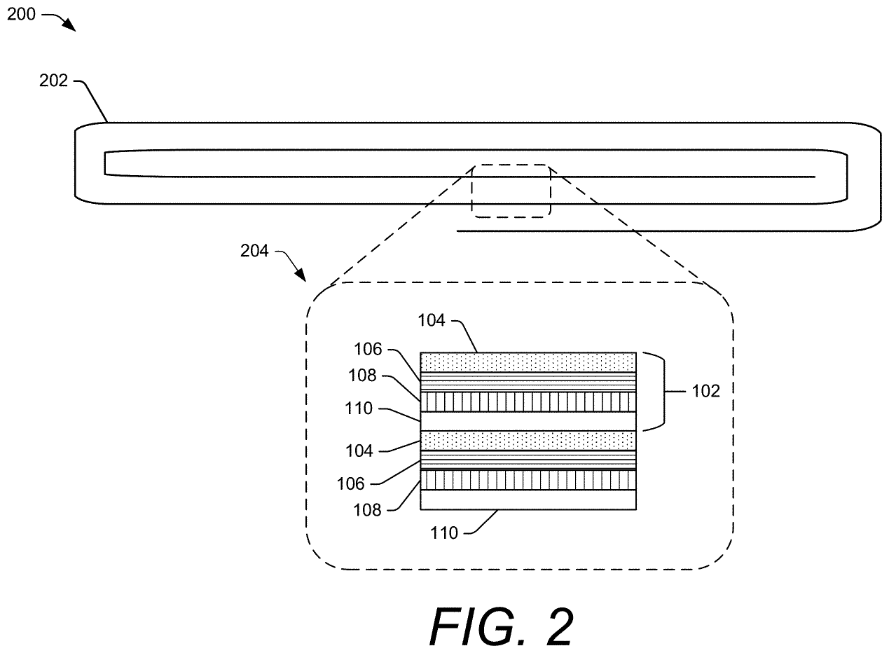

FIG. 2 illustrates an example implementation 200 of a battery cell configured as a jellyroll assembly 202. As illustrated, the set of layers 102, shown as a solid line, is wound into the jellyroll assembly 202. Also illustrated is a magnified view 204 of a portion of the jellyroll assembly 202, which shows the distinct layers of the set of layers 102. The ordering of the layers in the example implementation 200 is a same ordering of the layers from FIG. 1. Although a specific ordering of the layers is illustrated in the magnified view 204 of FIG. 2, the specific ordering is an example only. The ordering may be different, so long as the cathode layer 104 and the anode layer 108 are separated by either the separator layer 106 or the insulator layer 110 to prevent an electrical short.

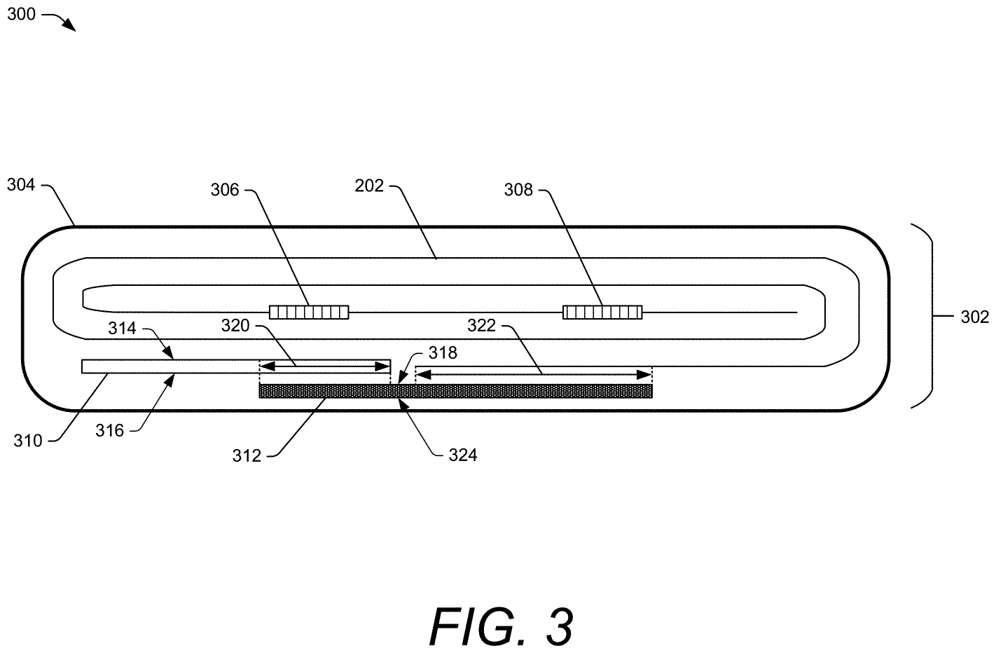

FIG. 3 illustrates an example implementation 300 of a battery pack 302. For the sake of clarity, some details, including interfaces and components, are omitted from FIG. 3. As illustrated, the battery cell configured as the jellyroll assembly 202 from FIG. 2 is disposed within a flexible pouch 304. A first electrically conductive tab 306 may physically connect to the cathode layer (e.g., the cathode layer 104 in FIG. 2) of the battery cell. A second electrically conductive tab 308 may physically connect to the anode layer (e.g., the anode layer 108 in FIG. 2) of the battery cell. Also illustrated are a first adhesive layer 310 and a second adhesive layer 312. The first adhesive layer 310 may be referred to as “green tape” (green tape 310). The second adhesive layer 312 may be referred to as “hot melt tape” (hot melt tape 312).

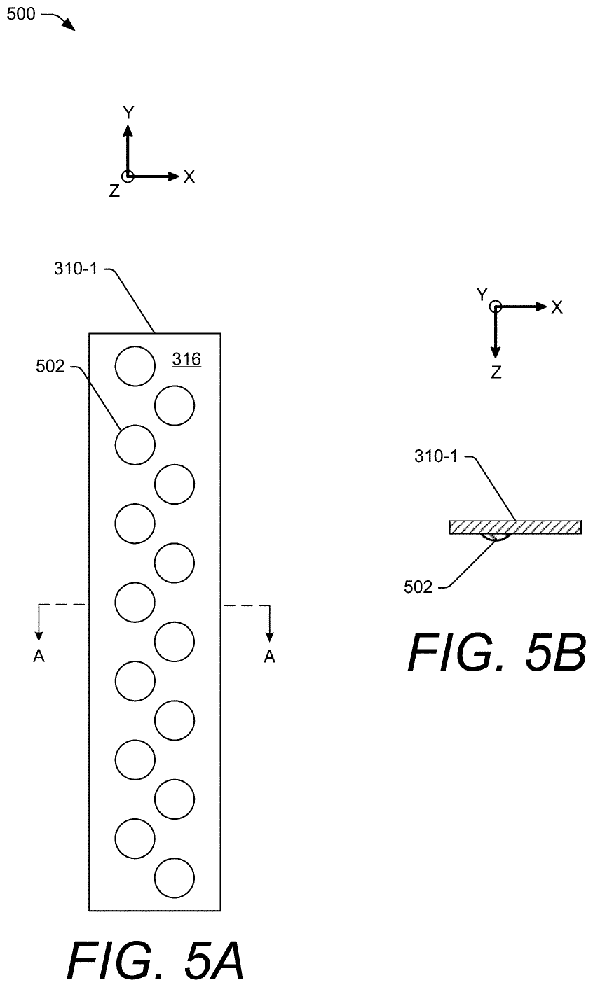

The green tape 310 may be made from a polyethylene terephthalate (PET) material. The green tape 310 may include a first surface 314 configured to contact an outer surface of the battery cell and a second surface 316 opposite the first surface. The second surface 316 may include a plurality of anchors configured to create friction points against a movement (e.g., a slidable movement) of the jellyroll assembly 202 relative to the flexible pouch 304. The plurality of anchors (e.g., described in relation to FIGS. 5-8) may be configured to reduce the movement of the jellyroll assembly 202 relative to the flexible pouch 304 by transferring or absorbing a momentum of the jellyroll assembly 202 within the flexible pouch 304.

During assembly of the battery pack 302, for example, the first surface of the green tape 310 may bond (e.g., adhesively) to the outer surface of the jellyroll assembly 202. A first surface 318 of the hot melt tape 312 may be pasted on top of an overlap portion 320 of the second surface 316 of the green tape 310 and an overlap portion 322 of the outer surface of the jellyroll assembly 202. The overlap portion 320 of the second surface 316 of the green tape 310 may be greater than one millimeter (mm), as an example. A second surface 324 opposite the first surface 318 of the hot melt tape 312 may adhere to the flexible pouch 304. The hot melt tape 312 may bond (e.g., adhesively, chemically) to the green tape 310, the jellyroll assembly 202, and the flexible pouch 304, which may be vacuum-sealed.

When subject to an exterior impact force (e.g., when dropped), for example, the hot melt tape 312 may reduce movement of the jellyroll assembly 202 relative to the flexible pouch 304. Further, the green tape 310 may reduce a chance of tearing the outermost winding of the set of layers 102 of the jellyroll assembly 202. Additionally, or optionally, the plurality of anchors of the green tape 310 may be configured to further reduce the movement of the jellyroll assembly 202 relative to the flexible pouch when subject to the exterior impact force.

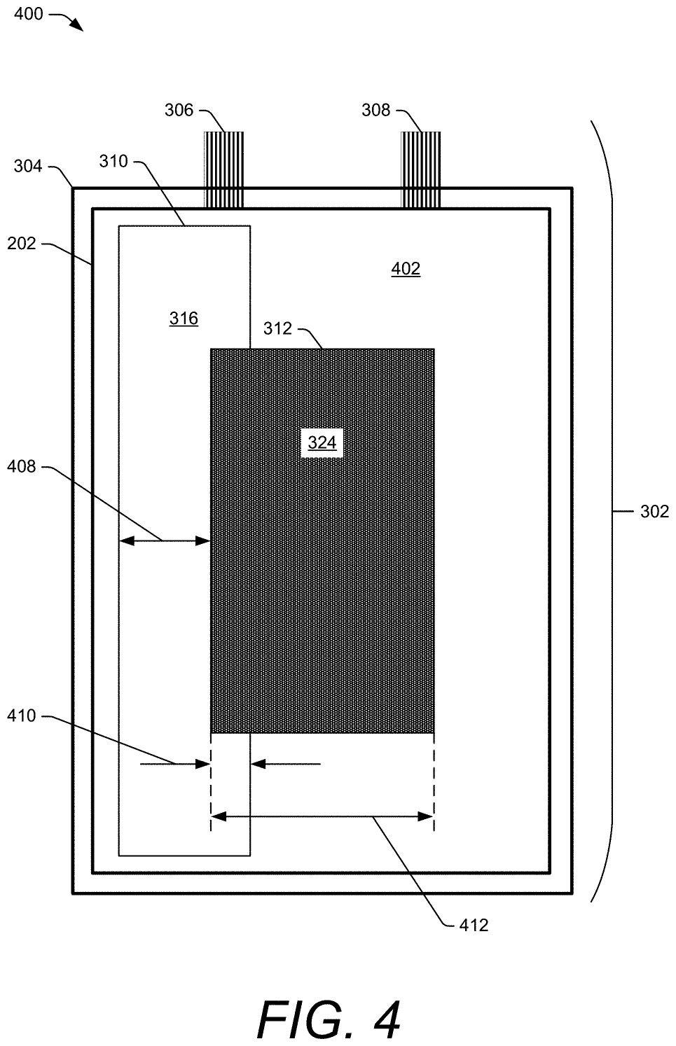

FIG. 4 illustrates a front view of an example implementation 400 of the battery pack 302 from FIG. 3. As illustrated, the first electrically conductive tab 306 and the second electrically conductive tab 308 exit the flexible pouch 304 at one end (e.g., “top”) of the battery pack 302. One of the two tabs connects to the cathode layer 104, while the other connects to the anode layer 108 of the battery cell, some details of which are omitted from FIG. 4 for the sake of clarity. Also illustrated in FIG. 4 are an outer surface 402 of the jellyroll assembly 202, the second surface 316 of the green tape 310, and the second surface 324 of the hot melt tape 312. As examples, a width 408 of the green tape 310 not covered by the hot melt tape 312 may be in a range of nine mm to 15 mm and a width 410 of the overlap portion 320 of the green tape 310 by the hot melt tape 312 may be greater than one mm. As an additional example, a width 412 the hot melt tape 312 may be in a range of 19 mm to 21 mm.

As mentioned, the second surface 316 of the green tape 310 may include a plurality of anchors configured to create friction points against movement of the jellyroll assembly 202 relative to the flexible pouch 304. FIGS. 5A and 5B illustrate an example implementation 500 of the green tape 310-1 having the plurality of anchors. FIG. 5A illustrates a front view of the green tape 310-1, the second surface 316 of which is shown. In this example, the plurality of anchors includes a pattern of bumps 502 (e.g., protrusions) extending from the second surface 316 of the green tape 310-1. FIG. 5B shows a cross-section view of the green tape 310-1, taken along line A-A, which includes a bump 502 from the pattern of bumps 502. Although a single pattern of bumps 502 of a single size is illustrated, the pattern and size of the bumps can be any pattern and size appropriate to create friction points against movement of the jellyroll assembly 202 relative to the flexible pouch 304. As illustrated in FIG. 5 and other FIGs. herein, the anchors (e.g., bumps 502) are configured to reduce the movement of the jellyroll assembly relative to the flexible pouch by absorbing a portion of the translation component of the movement of the jellyroll assembly in the x-direction and/or the y-direction (e.g., in an xy-plane defined by the second surface 316 of the green tape 310).

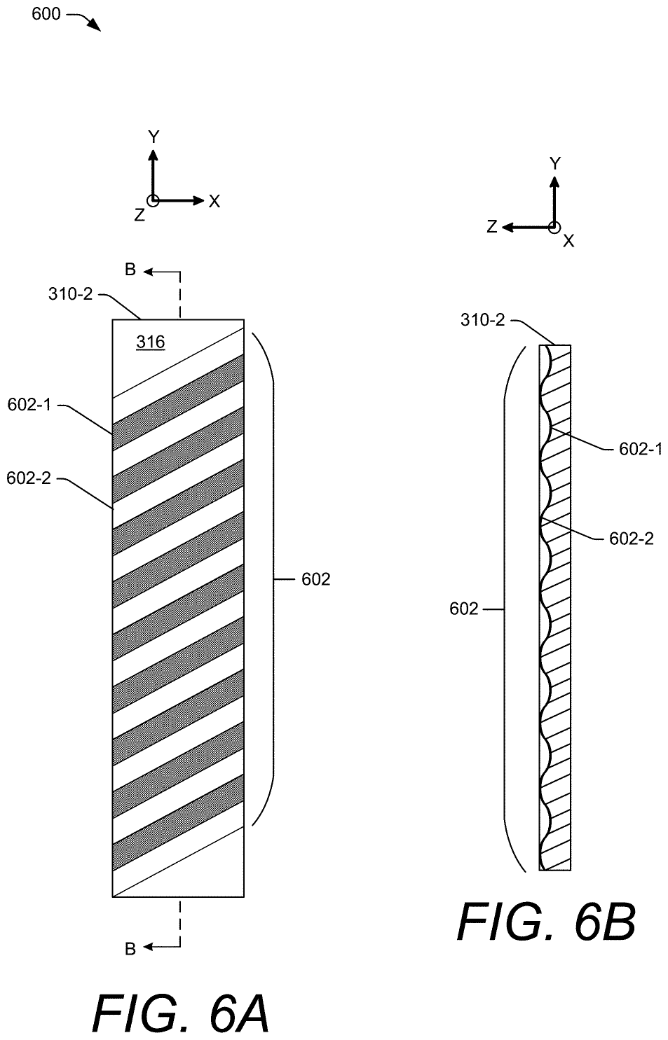

FIGS. 6A and 6B illustrate another example implementation 600 of the green tape 310-2 having the plurality of anchors. FIG. 6A illustrates a front view of the green tape 310-2, the second surface 316 of which is shown. In this example, the plurality of anchors includes a pattern of ripples 602 extending from the second surface 316 of the green tape 310-2. The shaded portions (e.g., portions 602-1) of the pattern of ripples 602 indicate concave portions (e.g., valleys) while the light portions (e.g., portions 602-2) indicate convex portions (e.g., peaks). FIG. 6B is a cross-section, taken along line B-B, of the green tape 310-2 including the pattern of ripples 602. As illustrated, the second surface 316 of the green tape 310-2 includes the concave and convex portions of the pattern of ripples 602. Although a single pattern of ripples 602 of a single size and orientation is illustrated, the pattern, size, and orientation of the ripples can be any pattern, size, and orientation appropriate to create friction points against movement of the jellyroll assembly 202 relative to the flexible pouch 304.

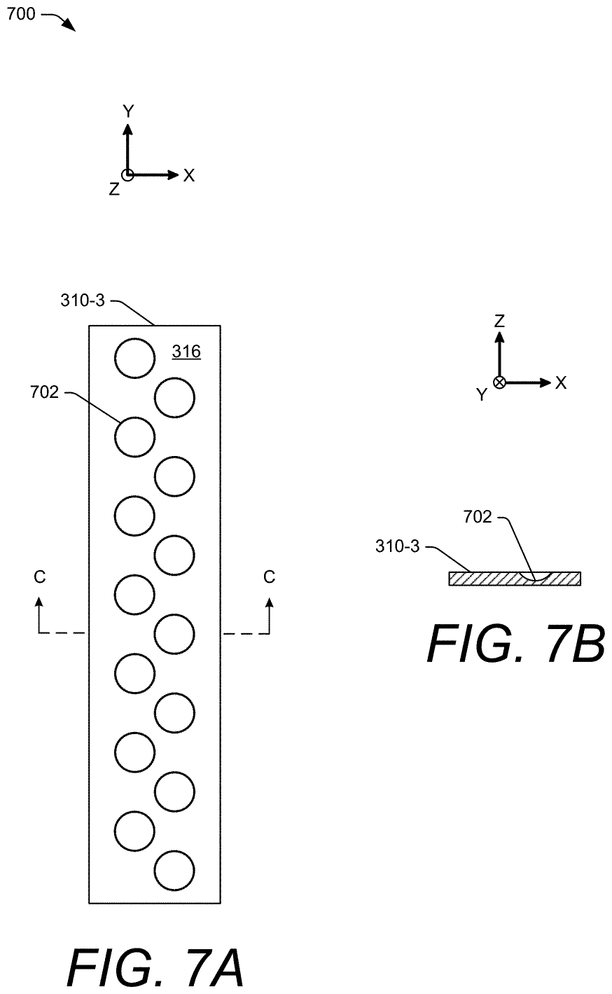

FIGS. 7A and 7B illustrate another example implementation 700 of the green tape 310-3 having the plurality of anchors. In this example, illustrated by detail view 700-1, the plurality of anchors includes a pattern of indentations 702 (e.g., recessed areas) in the second surface 316 of the green tape 310-3. FIG. 7B shows a cross-section view of the green tape 310-3, taken along line C-C and illustrating an indentation 702 from the pattern of indentations 702. Although a single pattern of indentations 702 of a single size is illustrated in FIG. 7A, the pattern and size of the indentations can be any pattern and size appropriate to create friction points against movement of the jellyroll assembly 202 relative to the flexible pouch 304.

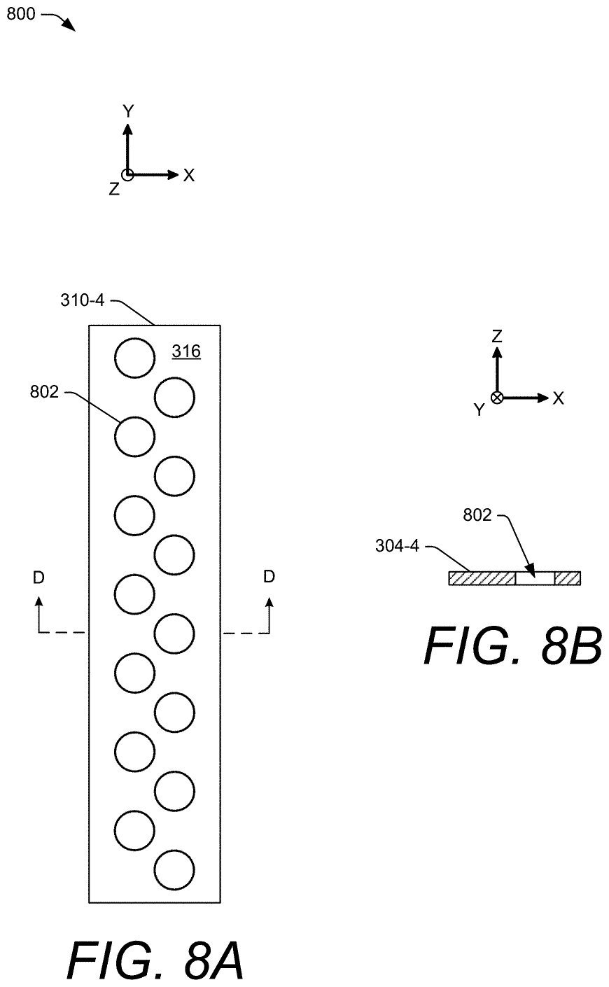

FIGS. 8A and 8B illustrate yet another example implementation 800 of the green tape 310-4 having the plurality of anchors. FIG. 8A illustrates a front view of the green tape 310-4, the second surface 316 of which is shown. In this example, the plurality of anchors includes a pattern of holes 802 in the green tape 310-4. The pattern of holes 802 is further illustrated in FIG. 8B, a cross-section view of the green tape 310 taken along line D-D. Although a single pattern of holes 802 of a single size is illustrated, the pattern and size of the holes can be any pattern and size appropriate to create friction points against movement of the jellyroll assembly 202 relative to the flexible pouch 304.

In implementations, the plurality of anchors can be any shape (e.g., pillar, cylinder, dome, spike, pinhole, channel, slot, recess), including, but not limited to, the bumps, ripples, indentations, and holes described in this discussion. The plurality of anchors can also be any size and orientation, so long as the plurality of anchors is configured to create friction points against movement of the jellyroll assembly 202 relative to the flexible pouch 304. In some implementations, during assembly of the battery pack 302, the plurality of anchors interlock with the flexible pouch based on a vacuum seal. Additionally, or optionally, the plurality of anchors interlock with the flexible pouch 304 based on a curing of the green tape 310 and the flexible pouch 304. In some implementations, the plurality of anchors may interlock with the hot melt tape 312 in the overlap portion 320 of the green tape 310 by the hot melt tape 312.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

Although concepts of techniques and apparatuses directed to a battery-cell-to-battery-pouch anchoring system have been described in language specific to techniques and/or apparatuses, it is to be understood that the subject of the appended claims is not necessarily limited to the specific techniques or apparatuses described. Rather, the specific techniques and apparatuses are disclosed as example implementations of a battery-cell-to-battery-pouch anchoring system.

What is claimed is:

1. A battery pack comprising:
a battery cell having a set of layers wound in a jellyroll assembly, the set of layers including an insulator layer, a cathode layer, an anode layer, and a separator layer disposed between the cathode layer and the anode layer;
a flexible pouch enclosing the set of layers; and
an anchoring system configured to anchor the battery cell to the flexible pouch, the anchoring system including:
an adhesive layer disposed within the flexible pouch between the flexible pouch and the jellyroll assembly, the adhesive layer including first and second opposing surfaces, the first surface configured to contact an outer surface of the battery cell; and
a plurality of anchors disposed on the second surface of the adhesive layer and configured to create friction points against movement of the jellyroll assembly relative to the flexible pouch.

2. The battery pack of claim 1, wherein the plurality of anchors is configured to reduce slidable movement between the jellyroll assembly and the flexible pouch.

3. The battery pack of claim 1, wherein the plurality of anchors is configured to reduce the movement of the jellyroll assembly relative to the flexible pouch by transferring at least a portion of a momentum of the jellyroll assembly within the flexible pouch.

4. The battery pack of claim 1, wherein the plurality of anchors includes a pattern of at least one of bumps or ripples extending from the second surface of the adhesive layer.

5. The battery pack of claim 1, wherein the plurality of anchors includes a pattern of indentations in the second surface of the adhesive layer.

6. The battery pack of claim 1, wherein the plurality of anchors includes a pattern of holes in the adhesive layer.

7. The battery pack of claim 1, wherein the plurality of anchors interlock with the flexible pouch based on a vacuum seal and curing of the adhesive layer and the flexible pouch.

8. The battery pack of claim 1, wherein the adhesive layer overlaps a second adhesive layer that seals the jellyroll assembly.

9. The battery pack of claim 1, wherein the adhesive layer has a width in a range of 9 millimeters to 15 millimeters.
